(19) United States
(12) Patent Application Publication
(10) Pub. No.: US 2023/0257260 A1
(43) Pub. Date: Aug. 17, 2023

(54) OPTIMIZED HYDROGEN PRODUCTION FROM A HYDROCARBON

(71) Applicant: PLENESYS, Valbonne (FR)

(72) Inventors: Ahmed KACEM, Vallauris (FR); Sabri TAKALI, Antibes (FR)

(21) Appl. No.: 18/006,896

(22) PCT Filed: Jul. 26, 2021
(86) PCT No.: PCT/EP2021/070893

§ 371 Date: Jan. 26, 2023

(30) Foreign Application Priority Data
Jul. 27, 2020 (FR) 2007864

(51) Int. Cl. C01B 3/24; C01B 3/56; B01J 6/00; B01J 4/00

(52) U.S. Cl. CPC C01B 3/24; C01B 3/56; B01J 6/008; B01J 4/001; C01B 2203/0272; C01B 2203/1241; C01B 2203/0861; C01B 2203/148; C01B 2203/042

(57) ABSTRACT

A process for manufacturing a dihydrogen-containing outlet gas, including injecting a hydrocarbon inlet gas into a reactor, an operation of cracking the inlet gas with a three-phase plasma torch, and then delivering the outlet gas. The manufacture is carried out from injecting the inlet gas into the reactor to delivering the outlet gas, without either the inlet gas or the outlet gas undergoing expansion.

### TECHNICAL FIELD OF THE INVENTION

The present invention relates to the production of dihydrogen from a hydrocarbon. More particularly, it finds application in the energy area and thus plays a crucial role in energy transition. It can also be advantageously applied for the refuelling of hydrogen vehicles the motor unit of which does not directly emit greenhouse gases or in industry.

### STATE OF THE ART

In the current context, there is considerable interest in solutions that attempt to respond to energy challenges. Climate change, scarcity of resources and multiplication of environmental health risks are consequences of an economic and social model that needs to change.

The ecological transition is a change towards a new model of sustainable development that renews consumption habits, production processes, ways of working and living together in order to meet the major environmental challenges.

Hydrogen is often presented as the energy of the future. It is an ultimate form of carbon-free fuel. However, its current production is accompanied by significant carbon dioxide emissions, in the order of 12 kg of carbon dioxide per kg of dihydrogen produced using the methane steam reforming process, which is the main method for reforming fossil resources accounting for 98% of the world's dihydrogen production. Although cheap, this type of process is responsible for 2.25% of global carbon dioxide emissions with a total of 720 million tonnes of carbon dioxide emitted into the atmosphere each year.

Research has been carried out on numerous processes or devices that allow the production of low-carbon hydrogen. The best known of these is water electrolysis.

Water electrolysis is a process that requires the installation of a device that consumes a lot of electric energy and is therefore relatively expensive. Furthermore, assigning non-carbon character to hydrogen produced by electrolysis requires electricity of non-carbon origin, which makes the process highly dependent on renewable energy. Renewable energies are already struggling to replace conventional, polluting power generation methods and are not in a position, either now or in the near future, to cover the growing consumption of electricity for the production of hydrogen by electrolysis.

Finally, there is a process that overcomes the above restrictions by making it possible to produce hydrogen without carbon dioxide emissions and at a much lower cost than electrolysis. This process is plasma cracking of hydrocarbons. The theoretical electricity consumption of this process is equal to 5.27 kWh per kg of dihydrogen produced versus 39.4 kWh per kg of dihydrogen produced for water electrolysis.

Hydrocarbon plasma cracking is a process already known from the state of the art. However, it should be noted that up to now, this process has been primarily used to produce carbon products and does not always allow for the production of hydrogen as the main product and at a competitive cost.

Indeed, the cracking operation consists in breaking the molecule of a hydrocarbon into smaller elements. The carbon products of this operation may be in a gaseous state or partly in a solid state.

Consequently, scientific and economic issues have led to the development of hydrocarbon cracking operations in the implementation of devices allowing the generation of solid or gaseous carbon products, without necessarily seeking to exploit hydrogen formed during the operation.

In practice, the carbon product is retained while the hydrogen present in the gas phase remains a by-product not exploited by the process.

The state of the art thus attests to a well-known process in which a plasma jet cracks hydrocarbons in order to extract essentially either carbon black or alkynes or alkenes.

The plasma cracking of hydrocarbons can eventually lead to the release of hydrogen in the form of dihydrogen. The hydrogen released by the reaction is then considered as a by-product since the process was previously focused on carbon products.

In order to be able to guarantee hydrogen as a usable product, for example in the field of mobility, hydrogen has to then be conditioned at pressures of several hundred bars.

Therefore, existing processes are not optimised for the production of hydrogen. Document FR2474043 A1 discloses a hydrocarbon cracking process using a plasma torch with nitrogen and oxygen as carrier gases in proportions that can be found in air. The cracking is carried out to essentially generate a carbon product, that is to produce “carbon black”.

In document US2016/296905 A1 a process is disclosed for separating dihydrogen and carbon by cracking a hydrocarbon using a tubular electrode torch and then a labyrinth allowing the carbon product to be trapped by gravity with an hourly process gas flow rate in the order of 1 m³/h. The main objective of this type of solution is the production of carbon and the recovery of carbon after an operating cycle.

It should therefore be noticed that among existing solutions for producing hydrogen using hydrocarbon cracking, the hydrogen produced is generally a by-product, that is a by-product mixed with other chemical elements within a gas phase whose conditioning does not allow for efficient operation.

In conclusion, the production by plasma cracking operation of a hydrocarbon does not allow the optimised production of dihydrogen as the main product and requires finding a process and device improving the existing one.

It is therefore an object of the present invention to provide an invention having as an objective the optimised and continuous production by plasma cracking operation of a hydrocarbon allowing the optimised and preferably continuous production of dihydrogen as the main product.

Further objects, characteristics and advantages of the present invention will become apparent from the following description and accompanying drawings. It is understood that further advantages may be incorporated.

### SUMMARY OF THE INVENTION

To achieve this objective, according to one embodiment, there is provided a process for manufacturing a dihydrogen-containing outlet gas, comprising injecting a hydrocarbon inlet gas, into a reactor, a cracking operation of the inlet gas by the plasma torch, and then delivering the outlet gas. The process being configured so that production takes place from injecting the inlet gas into the reactor to delivering the outlet gas, without either the inlet gas or the outlet gas undergoing an expansion of more than 20%, the plasma torch being supplied with three-phase current and the operation of cracking the inlet gas being carried out with a plasma, a carrier gas of which is a mixture comprising hydrogen and/or hydrocarbons, the process comprising at least one separation operation carried out downstream of the cracking operation in order to separate the outlet gas from a solid carbon product, part of the outlet gas being used, downstream of a separation operation, in the carrier gas.

Thus, this process has the feature of being able to generate dihydrogen under pressure, preferably with a satisfactory level of purity and therefore easily exploitable.

It is well known from the usual processes that carbon products can be produced by means of a plasma cracking operation. Actually, what is provided here is an advantageously optimised process that can be used to transform a hydrocarbon into dihydrogen.

The transformation is preferably carried out within a pressurised reactor by a plasma cracking operation. A hydrocarbon in a gaseous state is preferably injected under pressure into a reactor where the cracking operation is performed.

At the outlet of the reactor, the dihydrogen is advantageously delivered without having undergone expansion, that is the gas phase has not undergone expansion.

The process has the characteristics of a hydrocarbon plasma cracking but cracking is preferably carried out under pressure in order to obtain the most exploitable dihydrogen possible thereafter.

It is therefore advisable to contemplate hydrogen as a main product of the reaction. The hydrogen at the outlet of the device is, according to one example, at a pressure greater than or equal to the pressure at the inlet to the reactor or not exceeding a loss of more than 20%, since it passes through a device that is tight to pressure variations.

Advantageously, the dihydrogen at the reactor outlet is contained in a gas phase under pressure which makes it possible to minimise additional pressurisation steps at the outlet of the device. Thus, dihydrogen at the outlet of the device is more easily exploitable, as for example, it can be optimised for use as a fuel gas for adapted vehicles.

Indeed, the pressurisation step of bringing hydrogen to an operating pressure, such as the pressure used in hydrogen vehicles, is generally less complex and less expensive when done from an already high pressure, preferably above 4 bar.

In document FR2474043 A1, a hydrocarbon plasma cracking operation is disclosed which allows extraction of a carbon product accompanied by a gaseous discharge. This gaseous discharge is not exploited since it is only a by-product which may especially be comprised of polluting species. Furthermore, this document does not seem to set out any hydrogen production. The applicant noted that, counter-intuitively, the first bars of pressurisation are the most expensive. Indeed, to compress hydrogen from atmospheric pressure to 20 bar, the energy required is comparable to that for switching from 20 bar to 350 bar. In concrete terms, the theoretical energy required to compress hydrogen from 1 to 20 bar is equal to 5.31 MJ per kg of dihydrogen. This energy is equal to 4.96 MJ per kg of hydrogen for switching from 20 to 350 bar. On the other hand, the theoretical energy required to compress methane from 1 to 20 bar is equal to 0.61 MJ per kg of methane. Thus, even though the mass flow rate of methane to be compressed is four times that of hydrogen for the cracking process, compression of the upstream methane requires less than half the energy required to compress the downstream hydrogen. However, the energy required to compress methane can be free of charge from the point of view of the process, as the natural gas supplier can guarantee a minimum connection pressure of up to 42 bar at no extra cost.

Furthermore, operating under pressure allows the plant to be compact and the dimensions of the equipment to be reduced, thus reducing heat loss through the walls.

While conventional techniques suggest the use of single-phase DC torches as in US2016/296905 A1, a three-phase torch is advantageously used here. This plasma torch technology is in particular adapted for the production of dihydrogen by hydrocarbon cracking. Indeed, the cracking reaction requires a residence time of more than one second to obtain a quite high hydrogen production yield. The three-phase plasma torch has the ability to operate at very low gas velocities of less than 2 m/s, preferably less than 1 m/s (in the order of one m/s or less if necessary), unlike DC and tube electrode plasma torch technologies which are known for a high velocity plasma jet. This, consequently, makes the three-phase plasma torch adapted to manage and control the residence time and therefore the yield of the cracking reaction. A direct consequence of this is a reduced length of the reactor compared to a reactor coupled to a DC plasma torch, for an equal residence time. The heat losses will then be lower.

On the other hand, direct current and tubular electrode technologies do not allow continuous operation because they require the facility to be shut down to replace electrodes after they have eroded. Indeed, replacing the electrodes during operation in a tubular configuration is very complicated.

Another intrinsic advantage of using three-phase technology for a pressurised cracking operation lies in the very low head loss of the plasma gas, in contrast to direct current technology with a tubular electrode, which involves a head loss of several bars, making a cracking operation from 4 bar unattractive with this technology, as its use causes the inlet pressure to drop considerably.

According to a preferential possibility in this invention, hydrogen manufacture is carried out continuously, in particular without stopping the production in order to renew the electrodes by using the reloading system described in patent WO2020229408A1.

The cracking reaction can be maintained there, with a return loop of carrier gas from the outlet gas, forming a cycling assembly. With such a cycling, and with a maintenance in volume of worked gas, the applicant has noticed very good yields which result in obtaining hydrogen under pressure at the outlet (thus not necessarily implying a subsequent compression, or by limiting the energy impact) and a reduced electric consumption of the torch.

The reinjection of part of the outlet gas as a carrier gas acts in synergy with the three-phase torch to control the cracking reaction, insofar as this reinjection makes it possible to reintroduce residual hydrocarbon after cracking, it being remembered that hydrocarbons have a higher volumetric latent heat than light carrier gas, of the hydrogen type, which contains the rise in temperature in the reactor.

Another aspect relates to an apparatus for making a dihydrogen-containing outlet gas, comprising a line for injecting a hydrocarbon inlet gas into a reactor comprising a plasma torch configured to produce an operation of cracking the inlet gas and a line for delivering the outlet gas, the apparatus being configured so that inlet gas transits from being injected into the reactor to being returned as an outlet gas, without undergoing an expansion greater than 20%, the plasma torch being supplied with three-phase current and the device being configured so that the operation of cracking the inlet gas is carried out with a plasma, a carrier gas of which is a mixture comprising hydrogen and/or hydrocarbons, the device comprising a separator located downstream of the reactor and configured so as to allow separation of the gas mixture at the outlet of the reactor into an outlet gas and into a solid carbon product, the device being configured so that part of the outlet gas is reinjected into the carrier gas.

Nevertheless, it should be set out that the term without undergoing expansion can tolerate, in practice, a perceptible drop in relative pressure between an incoming gas and an outgoing gas from one of the elements of the device, such as a reactor, filter or separator.

However, it should also be set out that this expansion does not exceed a 20% drop in pressure relative to the pressure of the incoming gas with respect to the pressure of the gas leaving said elements of the device.

According to another separable aspect, a device and a process are provided for manufacturing a dihydrogen-containing outlet gas such that the pressure of a dihydrogen-based gas resulting from cracking, at least immediately at the outlet of the reactor, is greater than 4 bar, and preferably greater than or equal to 5 bar.

Preferably, alternatively, or additionally, this pressure immediately at the outlet of the reactor is greater than or equal to the pressure of the inlet gas entering the reactor.

### BRIEF DESCRIPTION OF THE FIGURES

The purposes, objects, characteristics and advantages of the invention will be better apparent from the detailed description of one embodiment thereof, which is illustrated by the following accompanying diagram in which:

FIG. 1 represents a simplified technical diagram of the device of the present invention.

FIG. 2 represents an alternative to the technical diagram of the device illustrated in FIG. 1.

The drawings and diagrams are always given by way of examples and are not limiting the invention. They are representations of principle in order to facilitate understanding of the invention and are not necessarily on the scale of practical applications.

### DETAILED DESCRIPTION

Before embarking on a detailed review of embodiments of the invention, optional characteristics are set out below which may possibly be used in combination or alternatively:

According to one example, the injection of the inlet gas 1 is carried out under an injection pressure p2, greater than or equal to 4 bar.

According to one embodiment, this makes it possible to anticipate reclaiming of the hydrogen produced. Indeed, as soon as the inlet gas 1 is injected into the reactor 11, a cracking operation advantageously takes place at an injection pressure p2 corresponding at least to a delivery pressure p3.

Thus, the cracking operation can advantageously be carried out using pressurised reactants. Indeed, the injection into a reactor 11 of a pressurised gas mixture containing hydrocarbons makes it possible to anticipate final pressurisation of the product.

As a result, the pressure level reached before the cracking operation is preferably at least equal to 4 bar and will not devalue until hydrogen is obtained at the end of the process. The injection of an inlet gas 1 at a pressure of at least 4 bar maximises reclaiming of the desired product, that is hydrogen, since the pressurisation of the H2 is ultimately necessary for its exploitability.

According to one example, the minimum temperature at which the cracking operation can be carried out within the device is 1200° C.

According to one example, the process comprises compressing to an injection pressure p2, upstream of injecting into the reactor 11.

According to one embodiment, this makes it possible to guarantee the technical effect set out above, namely the injection of the inlet gas 1 containing hydrocarbons into the reactor 11 at an injection pressure p2, the value of which can be chosen in order to optimise the correct operation of the process.

Indeed, the compression eventually allows the inlet gas 1 to rise in pressure from an intake pressure p1 to an injection pressure p2.

According to one example, the operation of cracking the inlet gas 1 is carried out with a plasma whose carrier gas 2 is a mixture of hydrogen and hydrocarbon.

According to one example, at the start of the process, it is possible to use a hydrogen feedstock as a carrier gas for the plasma.

Thus, the injection of hydrocarbon can advantageously start and recycling of a gas produced in the reactor to feed the plasma can start. The initial supply of hydrogen can then be stopped.

According to the example recited above, it should be noted that the hydrogen used for the start-up is not lost but is advantageously recovered as a product of the process. It is therefore possible to recover some of the hydrogen produced to restart the process without an external supply of hydrogen.

This makes it possible to increase the production yield and preferably not to discharge carbon dioxide. Indeed, cracking operations which use as carrier gas 2 a gas mixture comprising nitrogen and oxygen in the proportions in which they are found in the ambient air, can possibly release carbon dioxide or create toxic species such as cyanide.

According to one example, the process comprises at least one separation operation carried out downstream of the cracking operation to separate the outlet gas 3 from the solid carbon product 4.

The separation operation is likely to play a major role in the manufacture of the product, especially for the separation of the solid phase from the gas phase. Indeed, the plasma cracking of a hydrocarbon can result in the generation of a carbon product 4 in solid form.

Indeed, a cracking operation to produce hydrogen is all the more judicious if the carbon product is mainly obtained in its solid phase.

Thus, the purification of dihydrogen is facilitated since the separation of the solid phase from the gas phase can be carried out, for example, by using a particle filter. The remaining gas phase is therefore more concentrated in hydrogen. This makes it easier to achieve higher hydrogen purity levels.

According to one example, part of the outlet gas 3 is used, downstream of a separation process, in the carrier gas 2.

Since the carrier gas 2 used is, according to one example, a mixture of hydrocarbons and hydrogen, its presence at the outlet of the reactor 11 advantageously allows it to be reinjected as carrier gas 2.

Indeed, reinjecting the mixture of hydrocarbons and hydrogen as a carrier gas contributes to the optimisation of the material yield of the invention where the hydrocarbons remaining in gaseous form after the cracking operation can, according to one example, play the role of carrier gas 2. In the case of the present invention, the gas mixture resulting from the cracking operation is preferably comprised of hydrogen and hydrocarbon and can thus be reinjected as carrier gas 2 without having to fear the discharge of carbon dioxide.

According to one example, the process comprises a filtering operation carried out downstream of a separation operation so as to produce a purified outlet gas 6 with a higher concentration of dihydrogen than the outlet gas 3.

This filtering operation preferably allows the last remaining hydrocarbon molecules to be separated from the desirable dihydrogen. Indeed, following the separation operation, the gas phase and the solid phase could be well and truly separated, nevertheless, within the gas phase, it is advisable to contemplate the presence of hydrocarbons, as well as traces of other chemical elements such as nitrogen, carbon dioxide, helium, or hydrogen sulphide (H2S) which can be advantageously filtered by the filter 10 or upstream of the injection into the reactor 8.

Thus, the filtering operation contributes to the optimisation of the desired product, namely pressurised dihydrogen, preferably with the highest possible degree of purity.

According to one example, the purified outlet gas 6 is stored at a delivery pressure p3 greater than or equal to the injection pressure p2, and preferably strictly greater than the injection pressure p2.

This allows the advantageous accumulation of dihydrogen under pressure without fear of losses or dissipation of the product. Indeed the hydrogen produced, may require a storage container 15 in which it can be stored and then redistributed, preferably, to allow its industrial or commercial exploitation.

According to one example, the delivery pressure p3 is greater than or equal to 4 bar.

This makes it possible, for example, to obtain and store a product at a more easily exploitable pressure. Indeed, the pressure rise of a gas is all the more complex to implement as the gas is at a low delivery pressure p3.

According to one example, the filtering operation produces, further to the purified outlet gas 6, hydrocarbon gas which is reinjected into the plasma reactor 11.

Preferably, the filtering operation produces, further to the purified outlet gas 6, hydrocarbon gas which is reinjected with the carrier gas.

This possibly increases the material yield and advantageously limits hydrogen losses.

Indeed, at the end of the filtering operation, it is possible that hydrocarbon residues remain and they can then be reinjected into the reactor 11 so that a new extraction operation can take place therein.

According to one example, the inlet gas 1 is CH₄.

According to one example, part of the solid carbon products 4 is delivered and stored.

According to one example, the plasma torch 12 is supplied with three-phase current.

According to one example, the cracking operation is carried out continuously by virtue of the use of a plasma torch 12, provided with a continuous electrode supply system 5.

According to one example, the part of the outlet gas used in the carrier gas comprises CH₄.

According to one example, a plasma torch is used that is continuously fed with electrodes, preferably tightly to pressure variations inside the reactor and without stopping manufacturing the outlet gas.

According to another embodiment, the device is configured such that the injection line 13 comprises a plurality of injection holes opening into the reactor 11 and oriented in distinct and radial directions with respect to a direction of carrier gas flow 2 in the reactor 11.

This allows the hydrocarbon inlet gas 1 to be optimally distributed within the reactor 11 under pressure. Indeed in this way the use of an annular injection system will have the function, according to one example, of ensuring good penetration of the inlet gas 1, in the carrier gas in the plasma state, within the reactor 11.

According to another embodiment, the invention relates to a device comprising an inlet compressor 7 for the inlet gas 1 placed on the injection line 13.

This ensures that the inlet gas 1 is injected into the reactor 11 at the injection pressure p2.

Indeed, the inlet compressor 7 allows the inlet gas 1 to rise in pressure from an intake pressure p1 to an injection pressure p2.

According to another embodiment, the device in which the plasma torch 12 comprises electrodes 5 is configured in such a way as to have an active electrode, that is in operation in the reactor 11, by continuous and successive supply of the electrodes, and tightly to pressure variations inside the reactor 11. There is thus no pressure loss around the active electrode passing through the wall of the reactor 11.

This allows a pressure cracking operation to be carried out. Indeed, a reactor 11 configured so as to comprise electrodes 5 which can allow cracking under pressure makes it possible to anticipate a possible second compression of the product. Thus, the pressure level reached before the cracking operation will not devalue to the final product.

According to another embodiment, the device is tight to pressure variations, from the injection line 13 in the reactor 11 until it is returned from of the outlet gas 3.

This makes it possible to at least maintain the gas phase under pressure within the transformation without it having to undergo expansion.

Indeed, the tightness of the device preferably allows cracking under pressure and holding hydrogen without expansion.

According to another embodiment, the device comprises an outlet compressor 8 downstream or upstream of a storage element 15, from the delivery pressure p3 up to an operating pressure p4.

This may allow the produced hydrogen to be contained and subsequently used.

According to one particular embodiment, at least part of the solid carbon product 4 is delivered and stored.

This also optimises the yield of the transformation and adds generation of a carbon product 4, namely carbon in the solid state, to the production of hydrogen,. Indeed, a plasma cracking operation allows, in one embodiment, the optimised production of solid carbon from a hydrocarbon.

Advantageously, the hydrogen production is accompanied by a solid carbon by-product which does not affect the energy yield per kg of hydrogen. Thus, the cracking operation for hydrogen production can take place at temperatures above 1200° C.

The cracking operation is preferentially energy efficient as long as rising to high temperatures is avoided.

Further, a carbon black type production, for example, requires high temperatures, preferably around 2000° C., which lowers the energy balance of the process per kg of hydrogen.

Preferably, the plasma torch 12 is supplied with three-phase current.

Indeed, by using for example a three-phase plasma torch technology 12 for heat supply with a mixture of hydrogen and hydrocarbon as carrier gas 2, the present invention then has the necessary energy configuration to perform cracking of a hydrocarbon under pressure.

Indeed, the three-phase plasma torch technology is particularly adapted to this hydrogen production process as it has an ability to operate with rather low carrier gas velocities which allows to increase the residence time and to optimise hydrogen production.

According to one particular embodiment, the cracking operation is carried out continuously.

Indeed, hydrocarbon cracking for the production of hydrogen advantageously operates continuously by virtue of the use of a plasma torch 12 equipped with a continuous electrode supply system 5.

According to one particular embodiment, the device is configured so that cracking of the inlet gas 1 takes place under injection pressure p2 and then passes through elements which are tight to pressure variations.

Thus, according to one embodiment, the circulation of the reactants under pressure is beneficial for devices equipped with a plasma arc torch.

This is because the pressure rise in the device can drive, at equal power, an electric arc to an operating point at a voltage greater than or equal to the voltage associated with operation at atmospheric pressure.

Therefore, according to this example, the operating current under pressure is lower at equal power than at atmospheric pressure.

According to one particular embodiment, the device is configured:
in that part of the solid carbon product 4 is delivered and stored within a storage element specific to the preservation of the carbon product 4.
in that the plasma torch 12 is supplied with three-phase current.
in that the cracking operation is carried out continuously by virtue of the use of a plasma torch 12, equipped with a continuous electrode supply system 5.

According to one particular embodiment, the device is configured in that the injection line 13 comprises a plurality of injection holes oriented along distinct and radial directions with respect to a flow direction of a carrier gas 2 in the reactor 11.

According to one particular embodiment, the device is configured with an inlet compressor 7 of the inlet gas 1 placed on the injection line 13.

According to one particular embodiment, the device is configured in that the plasma torch 12 comprises electrodes 5 configured to be continuously fed tightly to pressure variations within the reactor 11.

According to one particular embodiment, the device is configured to be tight to pressure variations from the injection line 13 into the reactor 11 until it is returned from the outlet gas 3.

According to one particular embodiment, the device is configured in that it comprises an outlet compressor 8 downstream or upstream of a storage element 15, from a delivery pressure p3 of the outlet gas 3 to an operating pressure p4, configured so as to rise the pressure of the outlet gas 3 from a delivery pressure p3 to an operating pressure p4. It is set out that within the scope of the invention, the term “hydrogen” is recurrently used as the product targeted by the process and may comprise synonymously the term “dihydrogen” which means a molecular form of the element hydrogen that can exist in the gaseous state at the temperature and pressure conditions provided by the device.

Furthermore, it should be set out that the “hydrocarbon” used in the process and the device is preferably methane, known as “CH₄”. within the scope of the invention, it may also be the implementation of cracking methane or biomethane comprising a hydrocarbon or a mixture containing mainly CH₄.

Thus, the inlet gas 1, according to one example, consists of a hydrocarbon, which, in a literal sense, will be comprised essentially of carbon atoms and hydrogen atoms.

A distinction should be made between the different physical states of the reactants and products involved in the process and device of the present invention.

It should also be set out that the term “carbon product” is distinguished from the reactants as a product of the cracking reaction comprising a majority of carbon atoms.

For example, a distinction can be made between the “gas phase”, which corresponds to any reactant or product circulating within the device from intake to delivery in the gaseous state, and the “solid phase”, which for example is present through the carbon products in the solid state. The object of the present invention is to manufacture a product essentially consisting of hydrogen in a gaseous state. Therefore, more particular interest should be given to the chemical elements present in gaseous form.

It is set out that, within the scope of the invention, the term “inlet gas” 1 comprises the gas phase admitted at the beginning of the process. Thus, it should be considered that prior to the cracking operation, the inlet gas 1 is preferably the only gas phase considered.

Preferably, the inlet gas could extend to any hydrocarbon which is in a gaseous state or which can be transformed to a gaseous state, for example from a liquid state, especially by spraying.

It is set out that, within the scope of the invention, the term “carrier gas” 2, which may comprise the gas required to create a discharge within the reactor 11, may also be referred to as carrier gas.

Furthermore, within the scope of the invention, it should be set out that the term “outlet gas” 3, comprises the gas phase at the outlet of the reactor 11 where the cracking operation took place. Thus, the gas phase advantageously present within the device from the outlet of the reactor 11 to the filter 10 is referred to as outlet gas 3.

It is set out that within the scope of the invention, the term “carbon product” 4 comprises the solid phase resulting from the cracking operation within the reactor 11. Thus, the carbon product 4 is preferably generated and then separated from the gas phase during the separation step which takes place in the separator 9.

Furthermore, it is set out that within the scope of the invention, the term “purified outlet gas” 6 comprises the outlet gas 3 after possibly being filtered within the filter 10. Thus, it should be considered that the purified outlet gas 6 to be a gas mixture optimised in terms of its hydrogen content with respect to the outlet gas 3.

It is set out that within the scope of the invention, the term “reactor” 11 comprises the element of the device within which the cracking operation is performed. Reactor 11 is understood to mean any element capable of allowing the cracking of a hydrocarbon, preferably under the action of a carrier gas transformed into plasma.

“Inlet compressor” 7 will be understood to mean any device advantageously allowing the pressure of the inlet gas 1 to rise from the intake pressure p1 to the injection pressure p2.

It is set out that within the scope of the invention, the term “outlet compressor” 8 comprises any device allowing the rise in pressure of the outlet gas 6 from the delivery pressure p3 up to the operating pressure p4.

It is set out that in the scope of the present invention, the term “separator” 9 comprises any device element for separating the gas phase comprising the outlet gas 3 from the solid phase comprising, for example, the carbon product 4 at the outlet of the reactor 11.

It is set out that within the scope of the invention, the term “filter” 10 comprises any element of a device for purifying the outlet gas 3 into hydrogen.

It is set out that within the scope of the invention, the term “electrodes” 5 comprises any conductive element that may capture or release electrons within the device.

The term “storage element” 15 shall be understood to mean any element for containing, preserving or enclosing the outlet gas 3 or the purified outlet gas 6 at the end of the process.

The term “plasma torch” comprises any element which can advantageously partially ionise a gas by blowing it, for example, through a very energy dense electric arc.

The term “plasma torch” may also comprise induction plasma torches.

It is set out that within the scope of the invention, the term “intake pressure p1” relates to, according to one embodiment, the pressure at which the gas is introduced into the device.

It is set out that within the scope of the invention, the term “injection pressure p2” relates to, according to one embodiment, the pressure at which the inlet gas 1 is injected into the reactor 11.

It is set out that within the scope of the invention, the term “delivery pressure p3” relates to, according to one embodiment, the pressure at which the outlet gas 3 is delivered at the outlet of the reactor 11.

It is set out that within the scope of the invention, the term “operating pressure p4” relates to, according to one embodiment, the pressure at which the outlet gas 3 is stored within the storage element 15.

The present invention relates to a device for transforming a gaseous hydrocarbon into gaseous hydrogen. The transformation has the feature that the gas phases are not expanded, in other words, the incoming reactants to the outgoing products are not expanded.

According to one possibility, the absence of expansion is the result of the tightness of part of the transformation line, in particular at the reactor 11 in which cracking is carried out, and then in the dihydrogen delivery line 14. Thus, the injection pressure p2 is preserved. The terms “without expansion”, “without loss of pressure” and “tight” are understood as being able to admit slight pressure drops (of 20% at most) or some leaks, due, for example, to the tightness limits of some connections, or the zone where the active electrode of the plasma torch 12 passes through the wall of reactor 11. These slight pressure drops may also occur due to unavoidable head losses in the separator 9 or in the filter 10.

According to one embodiment, it may be that the injection pressure p2 slightly differs from the delivery pressure p3 so that p2 is higher than p3.

Indeed, in order for the inlet gas 1 to optimally penetrate the reactor 11, the inlet gas 1 may preferentially need to be conditioned to an injection pressure p2 higher than the pressure present within the reactor 11.

Typically, the term “without expansion” or “without pressure loss” may allow, in practice, for a slight expansion but not exceeding a 20% pressure drop relative to the injection pressure p2.

Therefore, it is suitable to focus on the gas pressure and not on the solid elements.

In the scope of the invention, an inlet gas 1 is admitted at an intake pressure p1 and is then preferably pressurised in an inlet compressor 7, which is understood to be any device for rising the pressure of a gas. The inlet compressor 7 can advantageously be mechanical or hydraulic.

The inlet gas 1 exits the inlet compressor 7 at an injection pressure p2 higher than the intake pressure p1.

The inlet gas 1 comprises and preferably consists of a hydrocarbon which undergoes a cracking operation under pressure within the reactor 11.

An injection of the inlet gas 1 into the reactor 11 is carried out under injection pressure p2.

The injection may be carried out via a plurality of injection holes opening into the reactor 11 and oriented in distinct and radial directions with respect to a carrier gas flow direction 2 in the reactor 11.

Thus, integrating an annular injection at the reactor 11 ensures better penetration of CH₄ or other inlet gas 1 into a plasma state phase in which the viscosity may be higher than that of a low temperature gas.

Alternatively, this operation may require adequate injection kinetic energy to allow plasma penetration into the reactor 11 and to condition the mixture between the hydrocarbon and the carrier gas 2 in the plasma state.

Indeed, at high pressure, the viscosity of the gases increases, which makes homogenisation of the mixture more difficult. An annular injection mainly makes it possible to improve the configuration of the flow and thus to control turbulence therein, especially if the injection holes are axially symmetrical.

Thus, a hydrocarbon cracking process is carried out according to one embodiment continuously by virtue of the use of a plasma torch 12 provided with a continuous electrode supply system 5.

Especially, the device may be equipped with an electrode supply device outside the reactor 11.

The latter may comprise a magazine for storing a plurality of standby electrodes 5 waiting to be used. In this embodiment, the supply device furthermore has a member for lowering an active electrode from outside the reactor 11, so that the active electrode is immersed in the interior volume of the reactor 11 and gradually descends as it wears out. When it is almost worn out, the active electrode is replaced by one of the standby electrodes.

This replacement can be done by connecting the outer end of the active electrode with a lower end of the standby electrode, so as to form a continuous assembly, the standby electrode ultimately replacing the active electrode during the downward movement in the reactor 11.

The cracking operation is carried out within the reactor 11 without pressure loss, so that the injection pressure p2 is maintained at a maximum by the tightness of the device.

According to one embodiment, the cracking operation is carried out using a three-phase plasma torch technology 12 for heat supply with a mixture of hydrogen and hydrocarbon as carrier gas 2.

According to one example, for a production capacity of 12 kg/h, it will be necessary to provide the device with a power in the order of 120 kW.

According to one example, for operation at 1 bar of the plasma torch, a voltage supply of 500 V and a current supply of 150 A should be provided.

In one example, for 20 bar operation of the plasma torch, a voltage supply of 1500 V and a current supply of 50 A should be provided.

Thus, the plasma cracking operation allows, for example, dissociation of an outlet gas 3 and a solid carbon product 4 within a heterogeneous mixture.

A heterogeneous mixture is produced and then advantageously undergoes a separation step within a separator 9 where the outlet gas 3 and the carbon product 4 are divided. This separation can be by gravity.

Thus, for example, a solid carbon product 4 or an outlet gas 3 consisting of a gas mixture comprising hydrogen and a hydrocarbon residue which may have remained after the cracking operation if the latter is not complete, can be recovered.

Part of the gas mixture comprising and typically comprised of hydrogen and the remainder of uncracked hydrocarbon, may according to one example, following the phase dissociation step, be used as at least part of the carrier gas 2 of the plasma torch, whose circulation in the reactor 11 generates the plasma. The part of the gas mixture can be advantageously mixed with CH₄, for example.

Indeed, recirculation of the outlet gas 3 as the carrier gas 2 for the plasma can make it possible:
to avoid the use of other carrier gases such as nitrogen or air, which can prevent, for example, the contamination of hydrogen or the production of HCN;
to recover part of the energy contained in the reaction gas with the aim of energy optimisation;
to crack part of the hydrocarbon within the discharge zone of the plasma torches 12 and thereby improve the cracking efficiency.

During the aforementioned steps, and according to one embodiment, graphitisation of the carbon may occur, namely the carbon advantageously dissociated by the cracking operation precipitates in the graphite state, especially by virtue of the increase in pressure of the device in which the reactants circulate and in which they undergo transformations.

According to one particular embodiment, the manufacturing device comprises a pumping system 16 on a recirculation line located downstream of the reactor 11 and the pumping system 16 is configured to redirect part of the mixture of hydrocarbons and hydrogen from the outlet of the reactor 11 to the carrier gas injection line. This compensates for the head loss due to the filtration system. Indeed, the reinjection of part of the gas produced in the torch requires a pressure equal or slightly higher than that of the main injection line.

According to one particular embodiment, the recirculation line for the mixture of hydrocarbon and hydrogen at the outlet of the reactor 11 is configured to direct the mixture at least in part to the plasma torch 12 and/or at least in part, within the reactor 11.

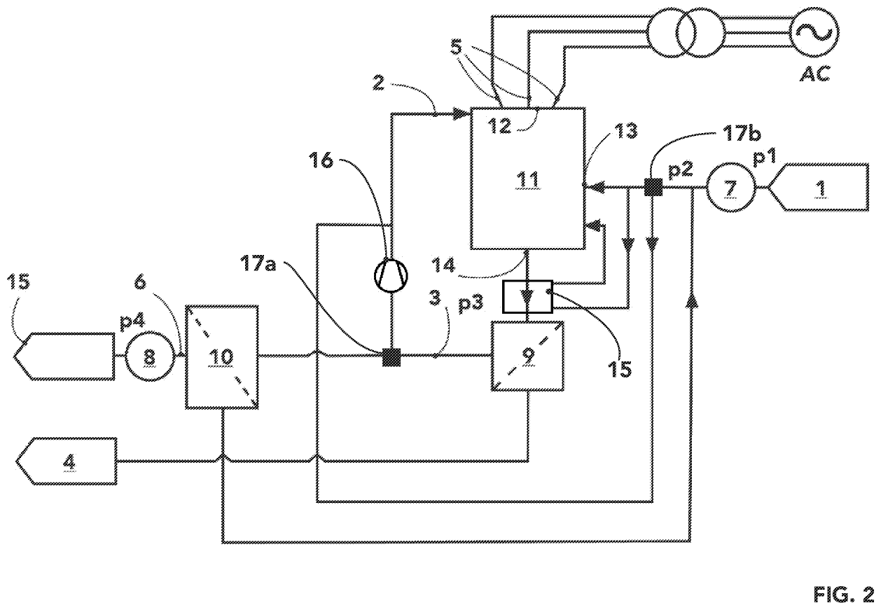

Preferably, as illustrated in FIG. 2, the device comprises at least a first adjustment device 17a comprising a regulating valve at the junction at the outlet of the reactor 11 between the recirculation line and the line leading to the filter 10. The first adjustment device 17a allowing to adjust the proportion of the gas mixture suitable to be recirculated for use as carrier gas 2. The device comprising at least one calculation unit able to communicate with the at least one regulating valve and configured to analyse data of said mixture and to allow servo-control of the adjustment. In this way, the device allows the amount of the elements that make up the recirculating gas mixture to be adjusted in proportion, thereby optimising the efficiency of the device 7.

Preferably, the first adjustment device is configured to regulate the proportion of methane (CH₄) in the carrier gas 2.

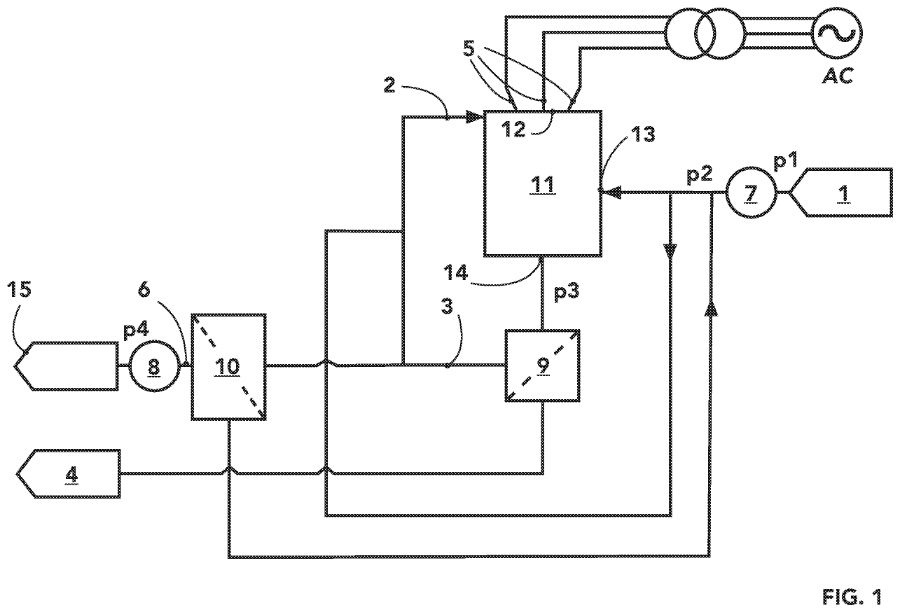

According to one particular embodiment, all the lines illustrated in the device in FIGS. 1 and 2 may comprise additional flow regulation means, and the whole may be controlled from a single central processing unit.

The carbon product 4 obtained can possibly be stored within a container for subsequent recovery and use.

As regards the outlet gas 3, it will circulate from the separation step to a filtration step which will make it possible to dissociate hydrogen from the hydrocarbons which have not been cracked.

Thus a filter 10, which is understood to be any element for filtering the outlet gas 3, enables the outlet gas 3 to be transformed into a purified outlet gas 6. The latter advantageously contains only hydrogen, for example with a purity level of more than 99%.

According to one example, at the outlet of the filter 10, two gas phases can be distinguished:
a purified outlet gas 6;
a gas mixture under delivery pressure p3 consisting of uncracked hydrocarbons and hydrogen;

According to one example, the purified outlet gas 6 essentially consists of dihydrogen at a delivery pressure p3.

According to one example, the purified outlet gas 6 can be further pressurised from a delivery pressure p3 to an operating pressure p4.

Indeed, an outlet compressor 8 preferably allows the purified outlet gas 6 to be risen in pressure from a delivery pressure p3 to an operating pressure p4.

Thus the purified outlet gas 6 is for example contained at the outlet of the device, within a storage element, at an operating pressure p4.

Thus, typically:
the injection pressure p2 is greater than or equal to the intake pressure p1. Only by way of example, it can be at least four times higher.
the delivery pressure p3 is greater than or equal to the injection pressure p2.
the operating pressure p4 is greater than or equal to the delivery pressure p3. Only by way of example, it can be at least ten times higher. Further or alternatively, the operating pressure p4 may be higher than 200 bar or even 300 bar.

Thus, according to this example, the process is carried out without expansion of the gas phases throughout the dihydrogen production steps.

According to one embodiment, part of the gas mixture under delivery pressure p3 made up of hydrocarbons and hydrogen, resulting from the filtration step is reintroduced at the inlet of the reactor 11.

This allows recirculation of the hydrocarbons in the device and hence optimises the efficiency of said device.

This reinjection of hydrocarbons can take place before or after the upstream compressor of the facility, if present. Preferably, reinjection of the hydrocarbons can be carried out in the carrier gas.

According to one particular embodiment, the separator 9 for separating the outlet gas 3 from the carbon product 4 downstream of the reactor 11 comprises, or even is a filter, preferably a buffer filter comprising vacuum-tight flange connections and having electro-polished surfaces for better handling of the elements on the nanometer scale (10⁻⁹-10⁻⁷ meters). Further, according to the same example, the separator 9 is configured to withstand temperatures of at least 200° C. This filtration system thus allows for continuous operation, preferably with the possibility of recovering carbon powder without the need for a shutdown with an airlock system.

According to one particular embodiment, the device comprises a heat exchanger 15 upstream of the separator 9 and downstream of the reactor 11. This heat exchanger 15 may be a gas-gas exchanger where the fresh gas may be at least part of the inlet gas 1 and/or at least part of the gas exiting the inlet compressor 7. Thus, the heat exchanger 15 allows the inlet gas 1 to at least partially recover heat from the gas mixture exiting the reactor 11.

Indeed, this allows the temperature of the gas mixture leaving the reactor 11 to be reduced before it enters the separator 9, thus avoiding damage to the device, regardless of the reaction yield in the reactor 11. Furthermore, the heat exchanger 15 makes it possible to improve energy efficiency of the process by recovering part of the waste heat from the gas mixture leaving the reactor 11 by transferring it to the inlet gas 1 which initially may be at ambient temperature. The heat exchanger 15 is configured so as not to induce a pressure drop greater than or equal to 20%.

According to one example, for a dihydrogen production capacity of 8 kg/h to 16 kg/h from methane, it will be necessary to provide the device with a power in the order of 80 to 160 kW. This production capacity corresponds to a mass flow of methane (CH₄), in the order of 30 to 70 kg/h. The flexibility of the plasma cracking operation allows it to operate at lower power levels, namely at least 20% of the plasma power, which corresponds to a minimum methane flow rate of 10 kg/h equivalent to 15 Nm³/h.

According to one example, the dihydrogen production capacity can be multiplied by a coefficient, for example by 10 or by 100 with scaling of all the equipment, without this scaling of the production capacity necessarily being linear with scaling of the dimensions of the facility.

Advantageously, all the flow rate and/or power values may be adapted accordingly and proportionally to the production capacity.

According to one particular embodiment, at the outlet of the separator 9, at the level of the recirculation line of the gas mixture towards the reactor 11, approximately 50% of the gas mixture containing a high percentage of hydrogen is able to be recirculated towards the reactor 11.

Furthermore, the device is configured so as to allow a hydrocarbon flow, preferably methane (CH₄), to be fed to said recirculation line or to the plasma torch 12.

According to one particular embodiment, the entire carrier gas 2 comprises at least part of the inlet gas 1 and/or at least part of the outlet gas 3.

Preferably, the entire carrier gas 2 comprises only part of the inlet gas 1 and/or only part of the outlet gas 3.

The flow rate is preferably between 8 kg/h and 16 kg/h, preferably between 10 kg/h and 14 kg/h and preferably up to 12 kg/h from the inlet gas 1 and having advantageously undergone compression in a compressor 7. This additional flow of methane makes it possible to reduce the temperature of the plasma gas or the carrier gas at the same power. For example, methane has a higher volumetric heat capacity than hydrogen at the same temperature and volumetric flow rate and can therefore contain more power.

The invention is not limited to the embodiments previously described and extends to all embodiments covered by the claims.

### LIST OF REFERENCE NUMERALS

1. Inlet gas
2. Carrier gas
3. Outlet gas
4. Carbon product
5. Electrodes
6. Purified outlet gas
7. Inlet compressor
8. Outlet compressor
9. Separator
10. Filter
11. Reactor
12. Plasma torch
13. Injection line
14. Delivery line
15. Heat exchanger
16. Pumping system
17a. First adjustment device
17b. Second adjustment device
15. Storage element
p1. Intake pressure
p2. Injection pressure
p3. Delivery pressure
p4. Operating pressure

1. A process for manufacturing a dihydrogen-containing outlet gas, comprising injecting a hydrocarbon inlet gas into a reactor with a plasma torch, an operation of cracking the inlet gas with the plasma torch, and then delivering the outlet gas, wherein the manufacture is carried out from injecting the inlet gas into the reactor to delivering the outlet gas, without either the inlet gas or the outlet gas undergoing an expansion greater than 20%, the plasma torch being supplied with three-phase current and the operation of cracking the inlet gas being carried out with a plasma a carrier gas of which is a mixture comprising hydrogen and/or hydrocarbons, the process comprising at least one separation operation carried out downstream of the cracking operation in order to separate the outlet gas from a solid carbon product, part of the outlet gas being used, downstream of a separation operation, in the carrier gas.

2. The process according to claim 1, wherein the injection of the inlet gas is carried out under an injection pressure, greater than or equal to 4 bar.

3. The process according to claim 1, comprising compressing to an injection pressure, upstream of the injection into the reactor.

4. The process according to claim 1, comprising a filtering operation carried out downstream of the separation operation so as to produce a purified outlet gas with a higher concentration of dihydrogen than the outlet gas.

5. The process according to claim 4, wherein the purified outlet gas is stored, at an operating pressure greater than or equal to the injection pressure.

6. The process according to claim 5, wherein the purified outlet gas is stored, at an operating pressure strictly higher than the injection pressure.

7. The process according to claim 1, wherein the filtering operation produces, in addition to the purified outlet gas, hydrocarbon gas which is reinjected into the reactor.

8. The process according to claim 1, wherein the inlet gas is CH₄.

9. The process according to claim 8, wherein the part of the outlet gas used in the carrier gas comprises CH₄.

10. The process according to claim 1, wherein a plasma torch is used which is continuously fed with electrodes tightly to pressure variations within the reactor, without stopping manufacturing the outlet gas.

11. A device for manufacturing a dihydrogen-containing outlet gas, comprising an injection line for a hydrocarbon inlet gas, into a reactor comprising a plasma torch configured to produce a cracking operation of the inlet gas and a delivery line for the outlet gas, the device being configured so that the inlet gas transits from its injection into the reactor until it is returned as outlet gas, without undergoing an expansion greater than 20%, the plasma torch being supplied with three-phase current and the device being configured so that the operation of cracking the inlet gas is carried out with a plasma a carrier gas of which is a mixture comprising hydrogen and/or hydrocarbons, the device comprising a separator located downstream of the reactor and configured so as to allow separation of the gas mixture at the outlet of the reactor into an outlet gas and a solid carbon product, and so that part of the outlet gas is reinjected into the carrier gas.

12. The device according to claim 11, wherein the injection line comprises a plurality of injection holes oriented in distinct and radial directions with respect to a flow direction of a carrier gas in the reactor.

13. The device according to claim 11, comprising an inlet compressor of the inlet gas placed on the injection line.

14. The device according to claim 11, wherein the plasma torch comprises electrodes configured to be fed continuously and tightly to pressure variations inside the reactor.

15. The device according to claim 11, said device being tight to pressure variations, from the injection line, into the reactor until it is returned from the outlet gas.

16. The device according to claim 11, comprising an outlet compressor downstream or upstream of a storage element, configured to rise the outlet gas in pressure from a delivery pressure to an operating pressure.

17. The device according to claim 11, comprising a pumping system on a recirculation line of the part of the outlet gas.

18. The device according to claim 11, comprising a heat exchanger upstream of the separator and downstream of the reactor.

19. The device according to claim 18, wherein the heat exchanger is a gas-gas exchanger where the fresh gas is at least part of the inlet gas.
